(19) United States
(12) Patent Application Publication
(10) Pub. No.: US 2025/0254641 A1
(43) Pub. Date: Aug. 7, 2025

(54) NETWORKED CONROLLING DEVICE FOR CONTROLLING WIRELESS NETWORKED NODES BASED ON POSITION AND ORIENTATION

(71) Applicant: STMicroelectronics International N.V., Geneva (CH)

(72) Inventors: Saurabh RAWAT, Noida (IN); Kumar Rahul TIWARI, Gautam Budh Nagar (IN); Prashant PANDEY, Greater Noida (IN)

(21) Appl. No.: 18/430,872

(22) Filed: Feb. 2, 2024

(51) Int. Cl. H04W 64/00; H04W 84/18

(52) U.S. Cl. CPC H04W 64/00; H04W 84/18

(57) ABSTRACT

An example networked controlling device, a wearable electronic device, and a computer-implemented method for using a networked controlling device to transmit a wireless control message to a target wireless networked node are provided. An example networked controlling device includes one or more processors configured to determine a position and an orientation of the networked controlling device relative to one or more wireless networked nodes in communication with a wireless network. The networked controlling device further configured to determine a pointing vector of the networked controlling device based at least in part on the position and the orientation; and transmit, on the wireless network, a wireless control message comprising pointing vector data representing the pointing vector, wherein the wireless control message is accepted by at least one wireless networked node of the one or more wireless networked nodes based at least in part on the pointing vector data.

### TECHNOLOGICAL FIELD

Embodiments of the present disclosure relate generally to control of wireless networked nodes on a wireless network, and more particularly, to control of a wireless networked node based on the position and orientation of a networked controlling device.

### BACKGROUND

With the growth of smart devices, smart homes, connected devices, and the Internet of Things (IoT) environment, numerous physical devices support wireless connectivity using Bluetooth, Wi-Fi, ZigBee, Matter, and other wireless communication protocols. Support of wireless connectivity over a wireless communication protocol enables remote control over various functions along with remote status of numerous device characteristics.

Applicant has identified many technical challenges and difficulties associated with the status and control of wirelessly connected devices. Through applied effort, ingenuity, and innovation, Applicant has solved problems related to the communicating control and status messages to one or more wirelessly connected devices, which are described in detail below.

### BRIEF SUMMARY

Various embodiments are directed to an example networked controlling device, wireless networked node, wearable electronic device, and computer-implemented method for using a networked controlling device to transmit a wireless control message to a target wireless networked node. A networked controlling device, may comprise one or more processors and one or more storage devices storing instructions that are operable, when executed by the one or more processors, to cause the one or more processors to: determine a position and an orientation of the networked controlling device relative to one or more wireless networked nodes in communication with a wireless network; determine a pointing vector of the networked controlling device based at least in part on the position and the orientation; and transmit, on the wireless network, a wireless control message comprising pointing vector data representing the pointing vector, wherein the wireless control message is accepted by at least one wireless networked node of the one or more wireless networked nodes based at least in part on the pointing vector data.

In some embodiments, the networked controlling device, further comprising a motion sensing device, wherein the orientation of the networked controlling device is determined based at least in part on the motion sensing device.

In some embodiments, the motion sensing device comprises an inertial measurement unit.

In some embodiments, the orientation of the networked controlling device is defined by three angles representing elemental rotations within a coordinate system, and wherein the pointing vector data comprises the three angles.

In some embodiments, the position is determined by a trilateration process based on a distance of the networked controlling device from a plurality of the one or more wireless networked nodes.

In some embodiments, the trilateration process comprises an ultra-wideband (UWB) trilateration process.

In some embodiments, the position is determined by a triangulation process.

In some embodiments, the one or more wireless networked nodes comprises a first wireless networked node, and a second wireless networked node, wherein the position of the networked controlling device is determined based at least in part on (a) a first distance between the first wireless networked node and the second wireless networked node, (b) a first angle of arrival of a first wireless message received at the first wireless networked node from the networked controlling device, and (c) a second angle of arrival of a second wireless message received at the second wireless networked node from the networked controlling device.

In some embodiments, the wireless control message is broadcast on the wireless network to all wireless networked nodes on the wireless network within range of the networked controlling device.

In some embodiments, the networked controlling device further comprises a pointing end, wherein the pointing vector originates at the pointing end of the networked controlling device. In some embodiments, the wireless network is a Bluetooth low-energy network.

A computer-implemented method for controlling a wireless networked node is further provided. In some embodiments, the method comprises: determining, by a networked controlling device, a position and an orientation of the networked controlling device relative to one or more wireless networked nodes in communication with a wireless network; determining a pointing vector of the networked controlling device based at least in part on the position and the orientation; and transmitting, on the wireless network, a wireless control message comprising pointing vector data representing the pointing vector, wherein the wireless control message is accepted by at least one wireless networked node of the one or more wireless networked nodes based at least in part on the pointing vector data.

In some embodiments, the orientation of the networked controlling device is determined based at least in part on a motion sensing device.

In some embodiments, the orientation of the networked controlling device is defined by three angles representing elemental rotations within a coordinate system, and wherein the pointing vector data comprises the three angles.

In some embodiments, the position is determined by a trilateration process based on a distance of the networked controlling device from a plurality of the one or more wireless networked nodes.

In some embodiments, the position is determined by a triangulation process.

In some embodiments, the wireless control message is broadcast on the wireless network to all wireless networked nodes on the wireless network within range of the networked controlling device.

In some embodiments, the wireless network is a Bluetooth low-energy network.

A wearable electronic device, including a networked controlling device configured to transmit a wireless control message to a target wireless networked node, is further provided. In some embodiments, the networked controlling device includes a user input mechanism, one or more processors, and one or more storage devices storing instructions that are operable, when executed by the one or more processors, to cause the one or more processors to: determine a position and an orientation of the networked controlling device relative to one or more wireless networked nodes in communication with a wireless network; determine a pointing vector of the networked controlling device based at least in part on the position and the orientation; and transmit, on the wireless network, a wireless control message based on a user input using the user input mechanism, wherein the wireless control message comprises pointing vector data representing the pointing vector, wherein the wireless control message is accepted by at least one wireless networked node of the one or more wireless networked nodes based at least in part on the pointing vector data. The wearable electronic device further including an attaching mechanism, configured to attach the networked controlling device to a portion of the user.

In some embodiments, the wearable electronic device further comprising a motion sensing device, wherein the orientation of the networked controlling device is determined based at least in part on the motion sensing device.

An example wireless networked node is further provided. In some embodiments, the example wireless networked node comprising one or more processors and one or more storage devices storing instructions that are operable, when executed by the one or more processors, to cause the one or more processors to: receive, from a wireless network, a wireless control message comprising pointing vector data representing the pointing vector of a networked controlling device, wherein the pointing vector is determined based on a position and an orientation of the networked controlling device relative to one or more wireless networked nodes comprising at least the wireless networked node; determine that the pointing vector intersects a wireless networked node location associated with the wireless network node; and execute one or more control message instructions based on the wireless control message.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an example networked device environment including wireless networked nodes in accordance with an example embodiment of the present disclosure.

FIG. 2 illustrates an example block diagram of a networked controlling device in accordance with an example embodiment of the present disclosure.

FIG. 3 depicts an example triangulation process for determining position of a networked controlling device in accordance with an example embodiment of the present disclosure.

FIG. 4 illustrates an example trilateration process for determining position of a networked controlling device in accordance with an example embodiment of the present disclosure.

FIG. 5 illustrates an example orientation of a networked controlling device in accordance with an example embodiment of the present disclosure.

FIG. 6 depicts an example wireless control message transmitted on a wireless network mesh in accordance with an example embodiment of the present disclosure.

FIG. 7 illustrates a block diagram of an example apparatus that can be specially configured in accordance with an example embodiment of the present disclosure.

FIG. 8 depicts an example wearable electronic device in accordance with an example embodiment of the present disclosure.

FIG. 9 depicts an example process for transmitting a wireless control message to a target wireless networked node with a networked controlling device in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

### Overview

Various example embodiments address technical problems associated with controlling and requesting status of a wireless networked node in a networked device environment. As will be appreciated, there are numerous example scenarios in which a user may desire to easily control or status a smart device, smart home device, connected device, Internet of Things (IoT) device, and/or other wireless networked node in a networked device environment containing a plurality of wireless networked nodes.

The growth of wireless networked nodes in all aspects of life creates networked device environments containing large numbers of physical devices supported by wireless connectivity over a wireless network. For example, wireless network nodes may include lamps, light bulbs, fans, appliances, TVs, cameras, doorbells, thermostats, furniture, blankets, cooktops, heating ventilation and air conditioning (HVAC) systems, and numerous other devices. Each of these wireless network nodes may provide an interface to a wireless network supporting various command and status wireless control messages. As an example, an appliance may allow a user to turn on, turn off, adjust settings, or otherwise control the appliance through a wireless network. In addition, a user may status the operation, error, state, or other parameters of the appliance through the wireless network.

Wireless networked nodes are generally controlled through an application on a computing device, such as a graphical user interface on a mobile phone. A user may connect to a wireless networked node connected to a wireless network based on a label, name, or other identifier discoverable by the application on the mobile device. Unfortunately, in a networked device environment with numerous wireless networked nodes, it may be difficult for a user to determine the wireless networked node to which the user wishes to communicate. Lack of naming conventions, non-descriptive names, and/or overlapping names may make it difficult for a user to identify the device in an application on the mobile device. In addition, in some environments the list of wireless connected devices may be lengthy, further complicating the selection and control process.

In the past, many devices have supported control with infrared (IR) communication remotes. However, due to the power and space required by an IR receiver, many wireless networked nodes do not support communication via IR transmission. In addition, IR transmission requires direct line-of-sight between an IR transmitter and an IR receiver on the wireless networked node. IR transmission is also limited to the range of the IR transmitter. Further, IR transmissions are unsecured, meaning anyone with an IR transmitter may control the remote device.

For these, reasons, there is a need for a mechanism to easily identify and remotely control and/or status wireless networked nodes.

The various example embodiments described herein utilize a networked controlling device configured to identify a target wireless networked node based on a pointing vector derived from the position and orientation of the networked controlling device. Pointing vector data enabling a wireless networked node to determine the pointing vector is transmitted in a wireless control message by the networked controlling device on the wireless network, to the wireless networked nodes in the networked device environment. In some embodiments, a wireless networked node may be configured to determine the pointing vector based on the pointing vector data and further determine the position of the wireless networked node in relation to the pointing vector. In an instance in which the position of the wireless networked node is within the path of the pointing vector, the wireless networked node may accept the associated wireless control message and execute instructions in accordance with the wireless control message. In an instance in which the position of the wireless networked node is not within the path of the pointing vector, the wireless networked node may ignore and/or re-transmit the wireless control message.

As a result of the herein described example embodiments and in some examples, the effectiveness of a networked controlling device for wireless networked nodes in a networked device environment may be greatly improved. For example, a networked controlling device in accordance with one or more example embodiments of the present disclosure may improve network communication over a wireless network. By transmitting a single command containing pointing vector data and the command or status payload, the amount of traffic on the wireless network may be reduced. Transmitting the pointing vector data and payload over a single transmission may eliminate one or more steps in the pairing process. Reduced network traffic due to the elimination of pairing steps may reduce interference and collisions on the wireless network, improving the speed and reliability of communication on the wireless network. In addition, a reduction in traffic on the wireless network may reduce queues and wait times on the wireless network, improving the speed of communication on the wireless network.

Identifying a target wireless networked node by transmitting pointing vector data may additionally reduce storage space required by a networked controlling device and associated wireless networked nodes. By identifying a wireless networked node based on the pointing vector data associated with the networked controlling device, a wireless networked node and a networked controlling device may not require storage of addresses and other identifying information of previously paired devices. Reduction in storage requirements may improve the overall performance of the networked controlling device and the wireless networked nodes.

Identifying a target wireless networked node by transmitting pointing vector data may further reduce the power necessary to operate a networked controlling device and wireless networked nodes. Identifying a target wireless networked node with pointing vector data in the wireless control message may reduce the number of transmissions a networked controlling device and wireless networked node may make in support of operation. For example, a wireless networked node may not be required to operate in an active mode at any point during operation.

In addition, enabling control and status of a wireless networked node based on the pointing vector of the of the networked controlling device may simplify the control and status of wireless networked nodes in a wireless network environment. For example, identifying a target wireless networked node based on the position and orientation eliminates a requirement to identify and pair with a wireless networked node previous to transmitting a wireless control message. This may be particularly advantageous in instances in which a networked device environment includes a large number of wireless networked nodes and/or ineffectively named wireless networked nodes.

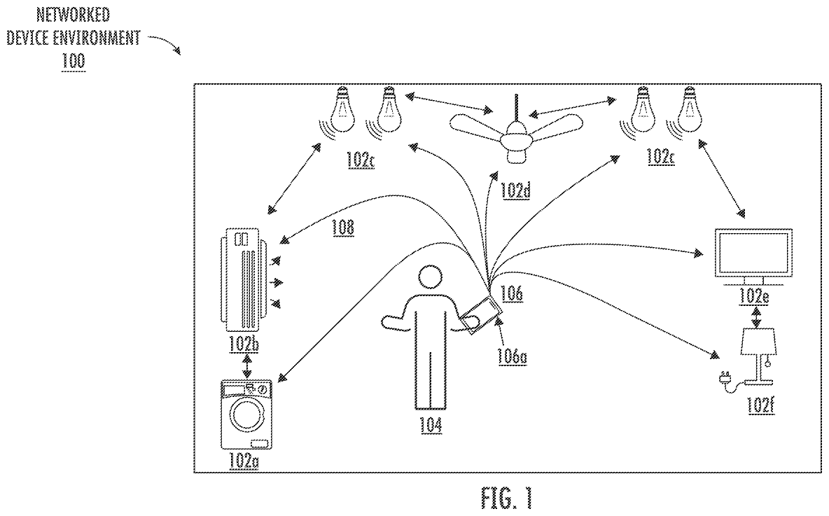

Referring now to FIG. 1, an example networked device environment 100 is provided. As depicted in FIG. 1, the example networked device environment 100 includes a plurality of wireless networked nodes 102a-102f and a user 104 operating a networked controlling device 106 configured to transmit wireless command messages and/or wireless status messages to the wireless networked nodes 102a-102f over a wireless network 108 according to a wireless network protocol.

As depicted in FIG. 1, the example networked device environment 100 includes a plurality of wireless networked nodes 102a-102f. A wireless networked node 102a-102f refers to any electronic computing device configured to connect wirelessly to a wireless network 108 and transmit data.

In some embodiments, a wireless networked node 102a-102f may comprise a smart device, smart home device, connected device, Internet of Things (IoT) device, and/or other non-standard computing device configured to connect to the wireless network 108 and accept commands and/or provide status. Non-limiting examples may include lamps (e.g., lamp 102f), light bulbs (e.g., light bulbs 102c), fans (e.g., fan 102d), appliances (e.g., appliance 102a), TVs (e.g., TV 102e), cameras, doorbells, thermostats, furniture, blankets, speakers (e.g., speaker 102b), and numerous other devices.

A wireless networked node 102a-102f is configured to interface with a wireless network 108. For example, a wireless networked node 102 may be configured to support transmission and receipt of messages according to a wireless network protocol, such as Bluetooth, Wi-Fi, Zigbee, Matter, or another similar wireless network protocol.

A wireless networked node 102a-102f is configured to receive command and status messages on the wireless network. Command messages include any messages prompting the execution of one or more tasks by the wireless networked node 102a-102f. For example, command messages may turn off or on the wireless networked node 102a-102f, adjust settings on the wireless networked node 102a-102f (e.g., volume, brightness, color, temperature, etc.), adjust the configuration of a wireless networked node 102a-102f, or other similar task. Status messages include any messages soliciting a responsive message from the wireless networked node 102a-102f. For example, status messages may request the current status of the wireless networked node 102a-102f, the status of one or more parameters of the wireless networked node 102a-102f, a sensor reading of the wireless networked node 102a-102f, current settings of the wireless networked node 102a-102f, or other similar status. A non-limiting example may include requesting the current temperature of a thermometer, the volume of a TV, the state of a light bulb, or something similar.

A wireless networked node 102a-102f may be configured to determine the position of the wireless networked node 102a-102f relative to a coordinate system defined within the networked device environment 100. A coordinate system may be any system of values, angles, or symbols by which a point in the networked device environment may be defined. For example, a position in three-dimensional space may be defined by three angles relative to three orthogonal coordinate axis; three distances from the orthogonal coordinate axis; an angle and two distances; or any combination thereof. In some embodiments, the origin of the coordinate system may be defined by the position of the networked controlling device 106. The wireless networked node 102a-102f in such an embodiment may use any sort of triangulation or trilateration technique relative to the networked controlling device 106 to determine the position of the wireless networked node 102a-102f. In some embodiments, the origin of the coordinate system may be defined as a fixed point in the networked device environment 100, for example, the corner of a room. In such an embodiment, the wireless networked node 102a-102f may be configured with the position of the wireless networked node 102a-102f relative to the coordinate system origin. For example, the location of the wireless networked node 102a-102f may be configured during setup.

As further depicted in FIG. 1, the networked device environment 100 includes a wireless network 108. A wireless network 108 refers to one or more devices communicating by radio frequency connections according to a wireless network protocol, as opposed to using cables or wires. A wireless network 108 may comprise a local area network (LAN), personal—are network (PAN), metropolitan-area network (MAN), a wide-area network (WAN), or other connection of devices. A wireless network 108 communicates in accordance with a wireless network protocol. A wireless network protocol is a set of standards that device the transmission and reception of data over a wireless network 108. Non-limiting examples of wireless network protocols may include Bluetooth, Bluetooth Low Energy (LE), ZigBee, LTE, 5G, Wi-Fi, and so on.

As further depicted in FIG. 1, the example networked device environment 100 includes a networked controlling device 106. A networked controlling device 106 refers to one or more electronic devices configured to interface with a wireless network 108 and transmit wireless control messages to one or more target wireless networked nodes 102a-102f based on the position and orientation of the networked controlling device 106.

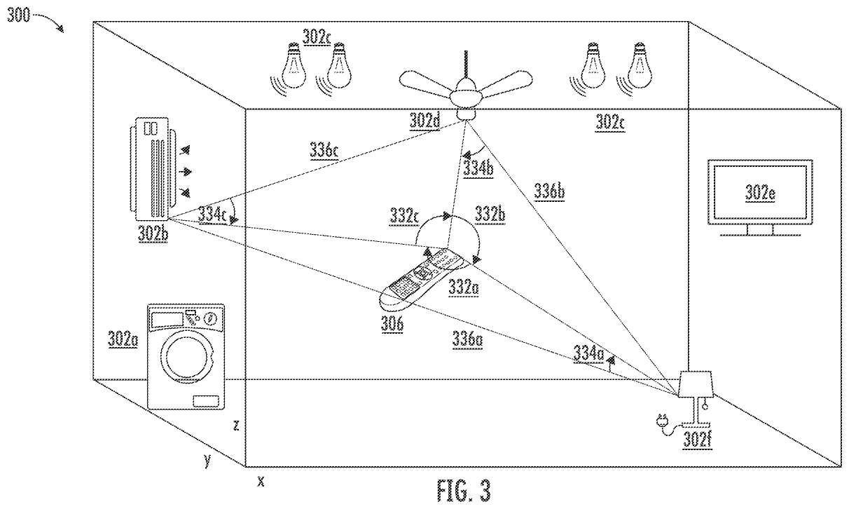

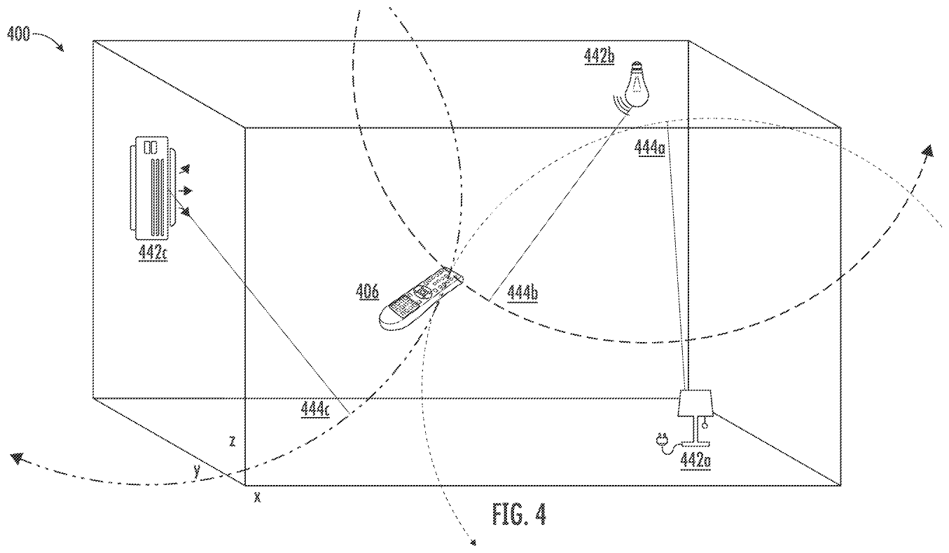

A networked controlling device 106 may utilize any means to determine the position of the networked controlling device 106. For example, a networked controlling device 106 may utilize GPS, proximity sensors, imaging techniques, triangulation, trilateration, or any combination thereof. A triangulation technique for determining the position of the networked controlling device 106 is described in relation to FIG. 3. A trilateration technique for determining the position of the networked controlling device 106 is described in relation to FIG. 4.

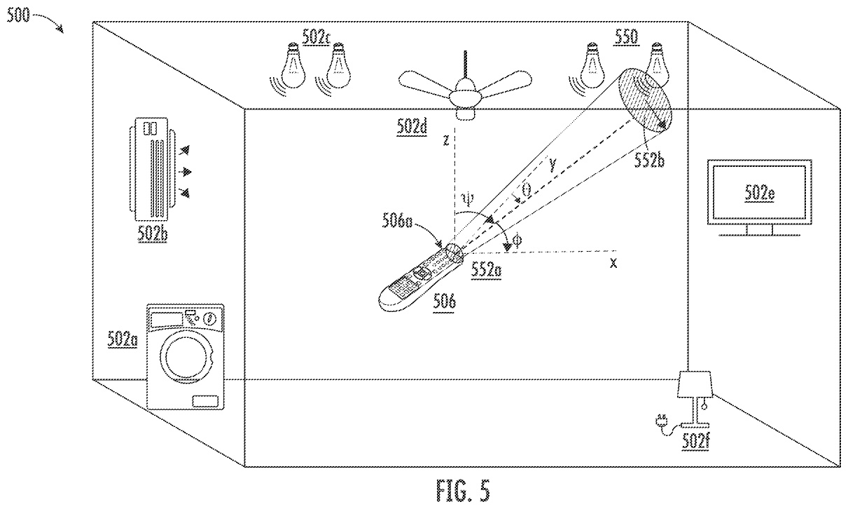

A networked controlling device 106 may utilize any means to determine the orientation of the networked controlling device 106. For example, a networked controlling device 106 may utilize motion sensing devices, such as one or more accelerometers, magnetometers, gyroscopes, inertial measurement units (IMUs), attitude and heading reference systems (AHRS), or other motion sensing devices. Orientation determination is described further in relation to FIG. 5. In some embodiments, a networked controlling device 106 may include a pointing end 106a. A pointing end 106a is any side, end, surface, etc. of the networked controlling device 106 labeled, indicated, or shaped to indicate a direction in which the networked controlling device 106 may be facing. For example, the networked controlling device 106 may comprise a form factor with an end formed to fit a user 104 hand and an opposite end (e.g., pointing end 106a) intended to indicate a direction. In some embodiments, a surface, for example, an outer surface of an augmented reality, virtual reality, or mixed reality headset, may be designated as a pointing end. The orientation of the networked controlling device 106 may be determined based on a pointing end 106a.

A networked controlling device 106 leverages the position and the orientation to determine a pointing vector. The pointing vector is utilized to determine a target wireless networked node 102a-102f for which a wireless control message is intended. The pointing vector may be represented by pointing vector data. Pointing vector data is any data that may be utilized to determine the pointing vector. For example, in some embodiments, a pointing vector may be represented by a cone, approximating the pointing direction and error associated with a given position and orientation of the networked controlling device 106. A plurality of dimensions necessary to reconstruct the cone may be transmitted as pointing vector data. The process of determining a pointing vector is further described in relation to FIG. 5.

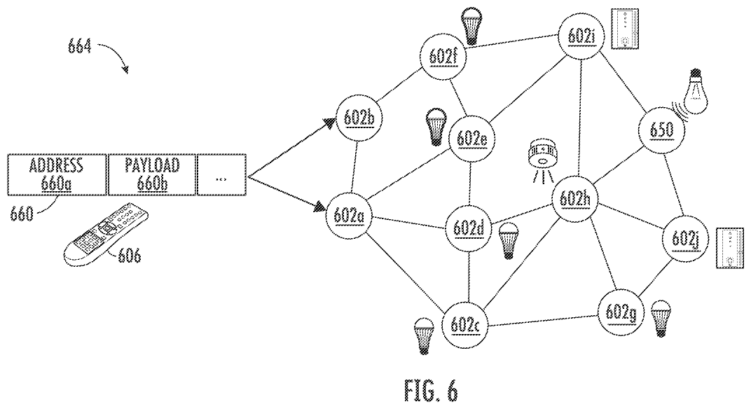

A networked controlling device 106 is further configured to transmit wireless control messages. Wireless control messages are any messages, including command messages and status messages intended for a target wireless networked node 102a-102f for purposes of initiating an action by the wireless networked node 102a-102f, and/or soliciting a status of one or more parameters of the wireless networked node 102a-102f. For example, a wireless control message may be transmitted to a target wireless networked node 102a-102f, requesting the wireless networked node 102a-102f to turn off or on. In another example, a wireless control message may be transmitted to a wireless networked node 102a-102f requesting a status related to the wireless networked node 102a-102f, such as a sensor reading. Wireless control messages are discussed further in relation to FIG. 6.

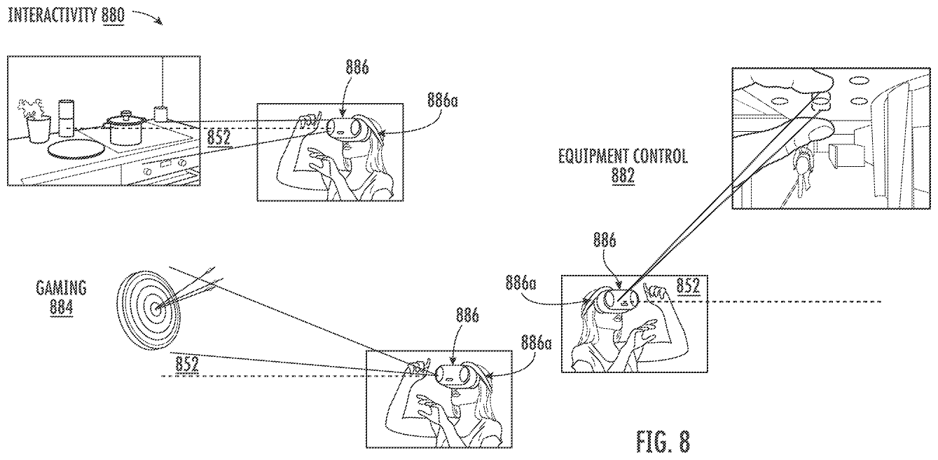

A networked controlling device 106 may comprise any form factor or housing. For example, a networked controlling device 106 may include ergonomic features to fit a hand of a user 104. In some embodiments, a networked controlling device 106 may comprise a wearable electronic device. For example, a networked controlling device 106 may comprise a watch, headset, glasses, ring, chest strap, or other similar device. Wearable electronic devices are further described in relation to FIG. 8. In some embodiments, the networked controlling device 106 may be implemented in conjunction with another mobile electronic device, such as a mobile phone, a mobile watch, a health tracker, a smart ring, and/or a similar mobile electronic device.

### Example Apparatus

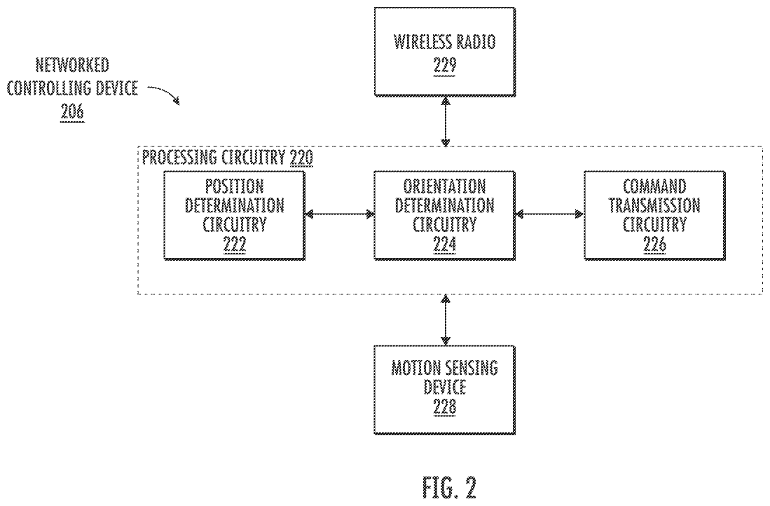

Referring now to FIG. 2, an example block diagram of a networked controlling device 206 is provided. As depicted in FIG. 2, the example networked controlling device 206 includes processing circuitry 220 comprising position determination circuitry 222, orientation determination circuitry 224, and command transmission circuitry 226. As further depicted in FIG. 2, the processing circuitry is electrically connected to a wireless radio 229 and a motion sensing device 228.

As depicted in FIG. 2, the example networked controlling device 206 includes a wireless radio 229. A wireless radio 229 refers to one or more wireless antennas configure to transmit and/or receive radio waves representing data values according to a wireless communication protocol. A wireless radio 229 is configured to receive data by resonating at a predetermined resonant frequency and decoding information based on the modulation of the received electromagnetic wave. A wireless radio 229 may further be configured to transmit wireless data by modulating an electromagnetic wave at a specified frequency to communicate data to a receiving radio within range of the wireless radio 229. In some embodiments, a wireless radio 229 may be configured to transmit and receive wireless data at a resonant frequency between 2400 and 2483.5 megahertz, for example, in an instance in which wireless data is transferred according to the Bluetooth or Bluetooth LE wireless communication protocol. A wireless networked node and/or a networked controlling device 206 may have limited power resources, thus, the wireless radio 229 may have a limited transmission range. In some embodiments, a wireless networked node may be configured as part of a mesh network, in which each wireless networked node is configured to relay wireless data until the wireless data is transmitted to the target wireless networked node. A mesh network is further described in relation to FIG. 6.

As further depicted in FIG. 2, the example networked controlling device 206 includes a motion sensing device 228. A motion sensing device 228 refers to any sensing device positioned on or in a networked controlling device 206 configured to determine motion, acceleration, rotation, specific gravity, angular rate, heading, or other parameters related to the orientation of the networked controlling device 206. In some embodiments, a motion sensing device 228 may include an accelerometer, magnetometer, gyroscope, inertial measurement unit (IMU), attitude and heading reference system (AHRS), or combination thereof. The motion sensing device 228 may be configured to determine the orientation of the networked controlling device 206 based on fixed forces. For example, the orientation of the networked controlling device 206 may be determined with respect to the force of gravity and/or the magnetic force of the earth. In addition, accelerometers and gyroscopes may determine the specific gravity and angular rate of the networked controlling device 206.

As further depicted in FIG. 2, the example processing circuitry 220 includes position determination circuitry 222. The position determination circuitry 222 refers to circuitry including hardware and/or software configured to determine the position of the networked controlling device 206 and/or one or more wireless networked nodes with reference to a determined coordinate system. In some embodiments, the position of the networked controlling device 206 may be relative to a fixed point in the networked device environment, such as a corner of the room or one of the wireless networked nodes. In some embodiments, the networked controlling device 206 may be defined as the origin of the coordinate systems and the positions of each of the wireless networked nodes may be defined in reference to the networked controlling device 206.

The position determination circuitry 222 may utilize any means to determine the position of the networked controlling device 206. For example, a networked controlling device 106 may utilize GPS, proximity sensors, imaging techniques, triangulation, trilateration, or any combination thereof. A triangulation technique for determining the position of the networked controlling device 206 is described in relation to FIG. 3. A trilateration technique for determining the position of the networked controlling device 206 is described in relation to FIG. 4.

As further depicted in FIG. 2, the example processing circuitry 220 includes orientation determination circuitry 224. The orientation determination circuitry 224 refers to circuitry including hardware and/or software configured to determine the orientation of the networked controlling device 206 relative to a determined coordinate system and/or one or more fixed forces, such as the force of gravity and/or the magnetic force of the earth. In some embodiments, the orientation determination circuitry 224 may be defined by three angles representing elemental rotations within a coordinate system.

For example, an x, y, z coordinate system may be utilized in which y is parallel to the earth's magnetic force, z is parallel to the earth's gravitational force, and x is orthogonal to both y and z. In such an embodiment, three angles may be determined to define the orientation of the networked controlling device 206, a first angle (@) representing the angle between the orientation of the networked controlling device 206 and the x-axis, a second angle (0) representing the angle between the orientation of the networked controlling device 206 and the y-axis, and a third angle (w) representing the angle between the orientation of the networked controlling device 206 and the z-axis of the room or environment coordinate system.

The orientation determination circuitry 224 may utilize one or more sensors comprising the motion sensing device 228 to determine the orientation of the networked controlling device 206.

As further depicted in FIG. 2, the example processing circuitry 220 includes command transmission circuitry 226. Command transmission circuitry 226 refers to circuitry including hardware and/or software configured to compile and transmit a wireless control message, including pointing vector data to one or more wireless networked nodes. Command transmission circuitry 226 may be configured to determine a pointing vector associated with the networked controlling device 206 based on the position and orientation determined by the position determination circuitry 222 and the orientation determination circuitry 224 respectively. The command transmission circuitry 226 may determine the parameters of the pointing vector that may be transmitted as pointing vector data such that the wireless networked nodes receiving the wireless control message may reconstruct the pointing vector. In some embodiments, the pointing vector data may include three angles representing the orientation of the networked controlling device 206. In one example, the three angles may comprise ϕ representing the angle between the orientation of the networked controlling device 206 and the x-axis, θ representing the angle between the orientation of the networked controlling device 206 and the y-axis, and ψ representing the angle between the orientation of the networked controlling device 206 and the z-axis.

Referring now to FIG. 3, an example triangulation process for determining the position of a networked controlling device 306 in a networked device environment 300 is depicted. As depicted in FIG. 3, the position of the networked controlling device 306 utilizing a triangulation process may be determined by determining the angles of arrival 334a-334c between the networked controlling device 306 and a plurality of wireless networked nodes 302a-302f with respect to a coordinate system (x, y, z), and utilizing the angles of arrival 334a-334c to triangulate the position of the networked controlling device 306 relative to the wireless networked node 302a-302f.

As depicted in FIG. 3, a triangulation process is utilized to determine the position of the networked controlling device 306 relative to the plurality of wireless networked nodes 302a-302f. The triangulation process refers to one or more algorithms, models, or processes leveraged by the networked controlling device 306 to determine the position of the networked controlling device 306 relative to three or more wireless networked nodes 302a-302f. The triangulation process may determine the distance to each of the three or more wireless networked nodes 302a-302f, the angle between each of the three or more wireless networked nodes 302a-302f relative to the networked controlling device 306, or other similar measurement necessary to position the networked controlling device 306 relative to the three or more wireless networked nodes 302a-302f.

One such triangulation process is to utilize Bluetooth direction finding to determine the angle of arrival and/or the angle of departure of a Bluetooth beacon signal at the three or more wireless networked nodes 302a-302f. Bluetooth direction finding may utilize an array of antennas and a beacon signal to determine the angle of arrival and/or the angle of departure of a Bluetooth signal. The angle of arrival corresponds to the angle at which a Bluetooth signal is received at a Bluetooth node (e.g., wireless networked node 302a-302f, networked controlling device 306). In addition, the distance between two Bluetooth nodes may be determined. For example, the distance between two fixed Bluetooth nodes may be configured at installation. In addition, the distance between two Bluetooth nodes may be determined using a received signal strength indicator (RSSI), ultra-wideband (UWB) time of flight measurements, or other similar distance measurements.

In the depicted example of FIG. 3, three Bluetooth nodes are utilized to determine the position of the networked controlling device 306, wireless networked node 302b, wireless networked node 302d, and wireless networked node 302f. The distance 336a between wireless networked node 302b and wireless networked node 302f, the distance 336b between wireless networked node 302f and wireless networked node 302d, and distance 336c between wireless networked node 302d and wireless networked node 302b may be determined using a Bluetooth distance finding technique, such as RSSI or UWB time of flight measurements. The angle of arrival 334a, 334b, and 334c may also be determined at each wireless networked node 302f, 302d, 302b using Bluetooth direction finding techniques. Given the distances 336a, 336b, and 336c, and the angles of arrival 334a, 334b, and 334c, the relative angles 332a, 332b, and 332c may be determined and the exact position of the networked controlling device 306 relative to the pre-determined coordinate system (e.g., x, y, z) determined.

Referring now to FIG. 4, an example trilateration process for determining the position of a networked controlling device 406 in a networked device environment 400 is depicted. As depicted in FIG. 4, the position of the networked controlling device 406 utilizing a trilateration may be determined by determining the distance 444a, 444b, 444c from each of three or more wireless networked nodes 442a, 442b, 442c and determining the common intersection point of the three or more distances 444a, 444b, 444c.

The trilateration process may utilize any technique to determine the distance between the networked controlling device 406 and a wireless networked node 442a, 442b, 442c. One such example is RSSI. RSSI utilizes the strength of the wireless signal received at the receiving wireless radio to determine an approximate distance between the transmitting wireless radio and the receiving wireless radio. Thus, as depicted in FIG. 4, the networked controlling device 406 may transmit a wireless signal received by wireless networked node 442a, or vice versa. The strength of the wireless signal received at the wireless networked node 442a may be leveraged to determine the distance 444a. Similarly, RSSI may be leveraged to compute the distance 444b between the networked controlling device 406 and the wireless networked node 442b; and the distance 444c between the networked controlling device 406 and the wireless networked node 442c.

Another technique to determine the distance between the networked controlling device 406 and a wireless networked node 442a, 442b, 442c, is to leverage the time of flight of the transmitted signal. In some embodiments, the networked controlling device 406 and the wireless networked node 442a, 442b, 442c may include a common clock enabling the determination of the time of flight of a timestamped wireless signal. Thus, as depicted in FIG. 4, the networked controlling device 406 may transmit a wireless signal containing a timestamp and received by wireless networked node 442a, or vice versa. The timestamp of the wireless signal received at the wireless networked node 442a may be leveraged to determine the time of flight of the wireless signal, and thus the distance 444a. Similarly, time of flight calculations may be leveraged to compute the distance 444b between the networked controlling device 406 and the wireless networked node 442b; and the distance 444c between the networked controlling device 406 and the wireless networked node 442c.

Once distances 444a, 444b, and 444c between the networked controlling device 406 and three or more wireless networked nodes 442a, 442b, and 442c are determined, the position of the networked controlling device 406 may be determined based on the intersection of the three distances 444a, 444b, and 444c indicating the position of the networked controlling device 406 relative to the wireless networked node 442a, 442b, 442c and/or a defined coordinate system.

Referring now to FIG. 5, a pointing vector 552 of an example networked controlling device 506 within a networked device environment 500 is depicted. As depicted in FIG. 5, the networked device environment 500 includes a plurality of wireless networked nodes 502a-502f, including a target wireless networked node 550 indicated by the pointing end 506a of the networked controlling device 506 and within the path of the pointing vector 552.

As depicted in FIG. 5, a pointing vector 552 may be indicated based on the position and orientation of the networked controlling device 506. A pointing vector 552 is any line, vector, or other geometric representation of the indicated direction of the networked controlling device 506. In some embodiments, the pointing vector 552 may include an error calculation, for example, as depicted in FIG. 5, the error of the pointing vector 552 is represented by a cone. As described in relation to FIG. 3 and FIG. 4, the position of the networked controlling device 506 may be determined by a trilateration, triangulation, or similar process. The position of the networked controlling device 506 may be described as a series of distances from the origin of the defined coordinate space, for example, three distances in a three-dimensional space. The position may further be described as a combination of distances and angles from the origin of the defined coordinate space.

As described in relation to FIG. 2, the orientation of the networked controlling device 506 may be determined based on one or more motion sensing devices (e.g., motion sensing device 228) accompanying the networked controlling device 506. From the motion sensing devices, an orientation of the networked controlling device 506 may be determined with respect to a defined coordinate system (e.g., x, y, z).

As depicted in FIG. 5, the example defined coordinate system x, y, z originates at the networked controlling device 506. In some embodiments, the defined coordinate system may originate at a fixed point, such as a fixed point within the networked device environment 500, or a fixed wireless networked node 502a-502f. In some embodiments, the defined coordinate system may be based on the orientation of the networked controlling device 506, and thus rotate and move as the networked controlling device 506 is rotated and moved.

As described herein, the orientation of the networked controlling device 506 may be defined by three or more angles (e.g., ϕ, θ, ψ) relative to the origin of the defined coordinate space x, y, z. The angles may represent elemental rotations relative to an axis of the defined coordinate space x, y, z. For example, in FIG. 5, ϕ represents the angle of the orientation of the networked controlling device 506 relative to the x-axis, θ represents the angle of the orientation of the networked controlling device 506 relative to the y-axis, and ψ represent the angle of the orientation of the networked controlling device 506 relative to the z-axis. In some embodiments, the three angles (ϕ, φ, ψ) may be the Euler angles of the pointing vector 552. Euler angles may be determined by the one or more motion sensing devices on the networked controlling device 506. For example, in one embodiment, an IMU may be configured to output quaternions (q₀, q₁, q₂, q₃) to describe the rotation and orientation of the networked controlling device 506 in three-dimensional space. The three angles may be derived from the quaternions using an equation, such as:

$$ϕ = arctan ( \frac{2 ( {q}_{0} {q}_{1} + {q}_{2} {q}_{3} )}{1 - 2 ( {q}_{1}^{2} + {q}_{2}^{2} )} )$$

$$θ = arctan ( 2 ( {q}_{0} {q}_{2} - {q}_{3} {q}_{1} ) )$$

$$ψ = arctan ( \frac{2 ( {q}_{0} {q}_{3} + {q}_{1} {q}_{2} )}{1 - 2 ( {q}_{2}^{2} + {q}_{3}^{2} )} )$$

As further depicted in FIG. 5, the pointing vector 552 may account for error. For example, the pointing vector 552 of FIG. 5 is represented as a cone, or frustum of a cone, with an axis centered on the pointing vector 552 as determined by the three angles. The radius 552a of the frustum of the cone represents error associated with the position determination of the networked controlling device 506. In addition, there is error associated with the orientation determination. The radius 552b of the frustum of the cone represents the error associated with the orientation of the networked controlling device 506 and associated pointing vector 552. As depicted in FIG. 5, the error of the pointing vector 552, represented by the frustum of the cone increases the farther a wireless networked node 502a-502f, 550 is removed from the networked controlling device 506. The pointing vector data transmitted in a wireless control message may include the parameters associated with the pointing vector 552 as well as error associated with the position and orientation of the networked controlling device 506.

As further depicted in FIG. 5, the networked controlling device 506 is directed at a target wireless networked node 550. The target wireless networked node 550 is any wireless networked node to which a wireless control message is to be transmitted. A target wireless networked node 550 is indicated by pointing the pointing end 506a of the networked controlling device 506 toward a wireless networked node (e.g., wireless networked nodes 502a-502f, 550). The wireless control message transmitted to the target wireless networked node 550 may include a status message and/or a command message. The wireless control message further includes pointing vector data indicating parameters of the pointing vector 552 necessary to determine the pointing vector 552. The wireless control message may further indicate an error, such as the radius 552a and/or 552b of the frustum of the cone representing the error in the position and/or orientation of the networked controlling device 506.

A target wireless networked node 550 is configured to determine the pointing vector 552 and associated error. The target wireless networked node 550 is further configured to determine its position relative to the defined coordinate system x, y, z for which the pointing vector 552 is defined. For example, if the defined coordinate system x, y, z is defined relative to the position of the networked controlling device 506, the target wireless networked node 550 is configured to determine its position relative to the networked controlling device 506. In another example, if the defined coordinate system x, y, z is defined relative to a fixed point in the networked device environment, the target wireless networked node 550 is configured to determine its position relative to the fixed point. With the equation for the pointing vector 552 and associated error determined, and the position of the target wireless networked node 550 relative to the defined coordinate system x, y, z, the target wireless networked node 550 may determine if the position of the target wireless networked node 550 intersects with the pointing vector 552, accounting for error.

In an instance in which the position of the target wireless networked node 550 intersects with the pointing vector 552, the target wireless networked node 550 receives the wireless control message and executes instructions based on the status message and/or command message included in the wireless control message. In an instance in which the position of the target wireless networked node 550 does not intersect with the pointing vector 552, the target wireless networked node 550 ignores and retransmits the wireless control message to wireless networked nodes 502a-502f within range.

Referring now to FIG. 6, an example wireless control message 660 transmitted on a wireless network mesh 664 comprising a plurality of wireless networked nodes 602a-602j, including the target wireless networked node 650, is depicted.

A wireless network mesh 664 refers to one or more wireless networked nodes 662a-662j, 664 configured to broadcast wireless data (e.g., wireless control messages 660) across multiple wireless networked nodes 662a-662j, 664 in order to transmit electrical signals between wireless networked nodes 662a-662j, 664. In some embodiments, a wireless network mesh 664 may be established on a Bluetooth LE network.

In operation, a designated controller wireless networked node 662a-662j, 664 on the Bluetooth LE wireless network mesh 664 provisions nodes joining the wireless network mesh 664. Provisioning involves assigning network credentials, unicast addresses, and configuration parameters to wireless networked nodes 662a-662j, 664 joining the wireless network mesh 664. A unicast address is a unique address of a Bluetooth LE wireless networked node 662a-662j, 664. In an instance in which a wireless control message 660 is directed towards a unique unicast address only intended wireless networked node 662a-662j, 664 accepts and executes the wireless control message 660. All other wireless networked node 662a-662j, 664 retransmit the wireless control message 660 on the wireless network mesh 664. A group address may also be assigned on a wireless network mesh 664. A Group Address is a multicast address which represents one or more wireless networked nodes 662a-662j, 664. All wireless networked nodes 662a-662j, 664 associated with the group address accept the wireless control message 660 and execute it. A wireless network mesh 664 may also utilize flooding. Mesh networks which use the flooding technique, broadcast a wireless control message 660 such that the wireless control message 660 is received by all wireless networked nodes 662a-662j, 664 within direct range of the transmitting wireless networked node 662a-662j, 664. The receiving wireless networked nodes 662a-662j, 664, in turn, relay the received wireless control message 660 by broadcasting it again such that it is received by another set of in-range wireless networked nodes 662a-662j, 664. Only wireless networked nodes 662a-662j, 664 to which the wireless control message 660 was addressed will accept and execute the wireless control message 660.

As further depicted in FIG. 6, an example wireless control message 660 is transmitted by a networked controlling device 606. A wireless control message 660 refers to one or more data constructs, packets, signals, or other data representations configured to be transmitted on a wireless network (e.g., wireless network mesh 664) according to a wireless network protocol. A wireless control message 660 may include an address 660a.

In one example embodiments, a networked controlling device 606 may store the locations of each of the wireless networked nodes 662a-662j, 650 in the wireless network mesh 664 relative to the define coordinate system. In such an instance, the networked controlling device 606 may compare the location of each of the wireless networked nodes 662a-662j, 650 to the determined pointing vector. One or more wireless networked nodes 662a-662j, 650 within the pointing vector may be identified as target wireless networked nodes 650. The address associated with the one or more target wireless networked nodes 650 may be retrieved based on the pointing vector. An address 660a may comprise a unicast address, identifying a single target wireless networked node 650, or a group address identifying a group of wireless networked nodes 662a-662j, 664. Only wireless networked nodes 662a-662j, 664 associated with the specified address accept and execute the wireless control message 660. Other wireless networked nodes 662a-662j, 664 retransmit the wireless control message 660 on the wireless network.

As further depicted in FIG. 6, the example wireless control message 660 includes a payload 660b. The payload 660b refers to any data comprising the body of the wireless control message 660. The payload 660b includes pointing vector data and a control message. The pointing vector data may include any data necessary to recreate a representation of the pointing vector (e.g., pointing vector 552 described in relation to FIG. 5). For example, pointing vector data may include the angles (e.g., ¢, 0, w) representing the orientation of the pointing vector line. The pointing vector data may further include error values associated with the pointing vector. Error values may include a tolerance associated with each angle. In addition, the pointing vector data may include data representing a geometric shape that accounts for the error in the pointing vector.

The payload 660b may further include status messages and/or command messages intended for the target wireless networked node 650. Command messages include any messages prompting the execution of one or more tasks by the target wireless networked node 650. For example, command messages may turn off or on the target wireless networked node 650, adjust settings on the target wireless networked node 650 (e.g., volume, brightness, color, temperature, etc.), adjust the configuration of a target wireless networked node 650, or other similar task. Status messages include any messages soliciting a responsive message from the target wireless networked node 650. For example, status messages may request the current status of the target wireless networked node 650, the status of one or more parameters of the target wireless networked node 650, a sensor reading of the target wireless networked node 650, current settings of the target wireless networked node 650, or other similar status. A non-limiting example may include requesting the current temperature of a thermometer, the volume of a TV, the state of a light bulb, or something similar.

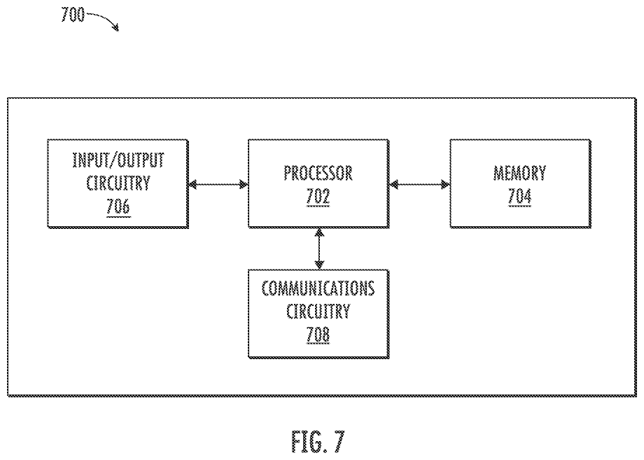

Referring now to FIG. 7, FIG. 7 illustrates a block diagram of an example apparatus 700 that can be specially configured in accordance with at least one example embodiment of the present disclosure. Specifically, FIG. 7 illustrates the networked controlling device 106, 206, 306, 406, 506, 606 apparatus in accordance with at least one example embodiment of the present disclosure. The networked controlling device 106, 206, 306, 406, 506, 606 apparatus includes processor 702, memory 704, input/output circuitry 706, and communications circuitry 708. In some embodiments, the networked controlling device 106, 206, 306, 406, 506, 606 apparatus is configured, using one or more of the sets of circuitry 702, 704, 706, and/or 708, to execute and perform one or more of the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the networked controlling device 106, 206, 306, 406, 506, 606 apparatus embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the networked controlling device 106, 206, 306, 406, 506, 606 apparatus provide or supplement the functionality of another particular set of circuitry. For example, the processor 702 in some embodiments provides processing functionality to any of the sets of circuitry, the memory 704 provides storage functionality to any of the sets of circuitry, the communications circuitry 708 provides network interface functionality to any of the sets of circuitry, and/or the like.

In some embodiments, the processor 702 (and/or co-processor or any other processing circuitry assisting or otherwise associated with the processor) is/are in communication with the memory 704 via a bus for passing information among components of the networked controlling device 106, 206, 306, 406, 506, 606 apparatus. In some embodiments, for example, the memory 704 is non-transitory and may include, for example, one or more volatile and/or non-volatile memories. In other words, for example, the memory 704 in some embodiments includes or embodies an electronic storage device (e.g., a computer readable storage medium). In some embodiments, the memory 704 is configured to store information, data, content, applications, instructions, or the like, for enabling the networked controlling device 106, 206, 306, 406, 506, 606 apparatus to carry out various functions in accordance with example embodiments of the present disclosure.

The processor 702 can be embodied in a number of different ways. For example, in some example embodiments, the processor 702 includes one or more processing devices configured to perform independently. Additionally or alternatively, in some embodiments, the processor 702 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the networked controlling device 106, 206, 306, 406, 506, 606 apparatus, and/or one or more remote or “cloud” processor(s) external to the networked controlling device 106, 206, 306, 406, 506, 606 apparatus.

In an example embodiment, the processor 702 is configured to execute instructions stored in the memory 704 or otherwise accessible to the processor. Alternatively or additionally, the processor 702 in some embodiments is configured to execute hard-coded functionality. As such, whether configured by hardware or software methods, or by a combination thereof, the processor 702 represents an entity (e.g., physically embodied in circuitry) capable of performing operations according to an embodiment of the present disclosure while configured accordingly. Alternatively or additionally, as another example in some example embodiments, when the processor 702 is embodied as an executor of software instructions, the instructions specifically configure the processor 702 to perform the algorithms embodied in the specific operations described herein when such instructions are executed. In some embodiments, the processor 702 includes or is embodied by a CPU, microprocessor, and/or the like that executes computer-coded instructions, for example stored via the non-transitory memory 704.

In some embodiments, the networked controlling device 106, 206, 306, 406, 506, 606 apparatus includes input/output circuitry 706 that provides output to the user and, in some embodiments, to receive an indication of a user input. In some embodiments, the input/output circuitry 706 is in communication with the processor 702 to provide such functionality. The input/output circuitry 706 may comprise one or more user interface(s) and in some embodiments includes a display that comprises the interface(s) rendered as an electronic interface, a web user interface, an application user interface, a user device, a backend system, or the like. In some embodiments, the input/output circuitry 706 also includes a keyboard, a mouse, a joystick, a touch screen, touch areas, soft keys a microphone, a speaker, or other input/output mechanisms. The processor 702 and/or input/output circuitry 706 comprising the processor can be configured to control one or more functions of one or more user interface elements through computer program instructions (e.g., software and/or firmware) stored on a memory accessible to the processor (e.g., memory 704, and/or the like). In some embodiments, the input/output circuitry 706 includes or utilizes a user-facing application to provide input/output functionality to a client device and/or other display associated with a user. In some embodiments, the input/output circuitry 706 includes hardware, software, firmware, and/or a combination thereof, that facilitates simultaneously display of particular data via a plurality of different devices.

In some embodiments, the networked controlling device 106, 206, 306, 406, 506, 606 apparatus includes communications circuitry 708. The communications circuitry 708 includes any means such as a device or circuitry embodied in either hardware or a combination of hardware and software that is configured to receive and/or transmit data from/to a network and/or any other device, circuitry, or module in communication with the networked controlling device 106, 206, 306, 406, 506, 606 apparatus. In this regard, in some embodiments the communications circuitry 708 includes, for example, a network interface for enabling communications with a wired or wireless communications network. Additionally or alternatively in some embodiments, the communications circuitry 708 includes one or more network interface card(s), antenna(s), bus(es), switch(es), router(s), modem(s), and supporting hardware, firmware, and/or software, or any other device suitable for enabling communications via one or more communications network(s). Additionally or alternatively, the communications circuitry 708 includes circuitry for interacting with the antenna(s) and/or other hardware or software to cause transmission of signals via the antenna(s) or to handle receipt of signals received via the antenna(s). In some embodiments, the communications circuitry 708 enables transmission to and/or receipt of data from a client device, capture device, and/or other external computing device in communication with the networked controlling device 106, 206, 306, 406, 506, 606 apparatus.

Additionally or alternatively, in some embodiments, two or more of the sets of circuitries 702-708 are combinable. Alternatively or additionally, in some embodiments, one or more of the sets of circuitry perform some or all of the functionality described associated with another component. For example, in some embodiments, two or more of the sets of circuitry 702-708 are combined into a single module embodied in hardware, software, firmware, and/or a combination thereof. Similarly, in some embodiments, one or more of the sets of circuitry, is/are combined with the processor 702, such that the processor 702 performs one or more of the operations described above with respect to each of these sets of circuitry 704-708.

### Example Wearable Electronic Device

Referring now to FIG. 8, an example wearable electronic device 886 comprising an attaching mechanism 886a is provided. A wearable electronic device 886 refers to one or more electronic devices configured to be worn on a portion of a user's body. In some embodiments, a wearable electronic device 886 may comprise a user interface, facilitating interaction with the wearable electronic device 886. Non-limiting examples of wearable electronic devices 886 include watches, headsets, glasses, rings, chest straps, or other similar device. In some embodiments, the wearable electronic device 886 may comprise a networked controlling device (e.g., networked controlling device 106, 206, 306, 406, 506, 606). A networked controlling device facilitates the transmission of wireless control messages to one or more wireless networked nodes. In some embodiments, the wearable electronic device may have a pointing end, or surface, for example, the face of a wearable headset, or a side of a ring.

A wearable electronic device 886 may further include an attaching mechanism 886a. An attaching mechanism 886a is any strap, clip, hook, frame, or other structure configured to attach the wearable electronic device 886 to a portion of the user. In some embodiments, the attaching mechanism 886a may be based on the shape of the wearable electronic device 886 or a feature of the wearable electronic device 886. For example, a ring may be shaped to fit on the finger of a user, or smart glasses may be shaped to rest on the face of a user.

As further depicted in FIG. 8, a wearable electronic device 886 comprising a networked controlling device may enable various use cases. For example, a wearable electronic device 886 comprising a networked controlling device may enable interactivity 880 with the user's environment. A user may look at, point to, or otherwise direct a pointing vector 852 to indicate a target wireless networked node. The user may control or status the target wireless networked node indicated. For example, the user may request temperature or state of the stove. The user may further turn on or turn off the stove.

A wearable electronic device 886 comprising a networked controlling device may further enable equipment control 882. In some embodiments, one or more gestures, phrases, or other inputs may accompany an indication of a target wireless networked node via a pointing vector 852. For example, identifying a light with a pointing vector accompanied by a user pinching fingers may enable the transmission of a wireless command message requesting the target light to turn off. Various other gestures such as hand motions, facial motions, head movements, body movements, and so on, may indicate a command or status message associated with the target wireless networked node. For example, a thumbs up while identifying a wireless enabled speaker with a pointing vector may initiate transmission of a wireless control message with a command message requesting the speaker to turn the volume up.

A wearable electronic device 886 comprising a networked controlling device may further enable gaming 884. In some embodiments, one or more gestures, phrases, or other inputs may accompany an indication of a target wireless networked node via a pointing vector 852 as part of a gaming experience. Mixed reality headsets may be candidates for such gaming functionality.

### Example Method

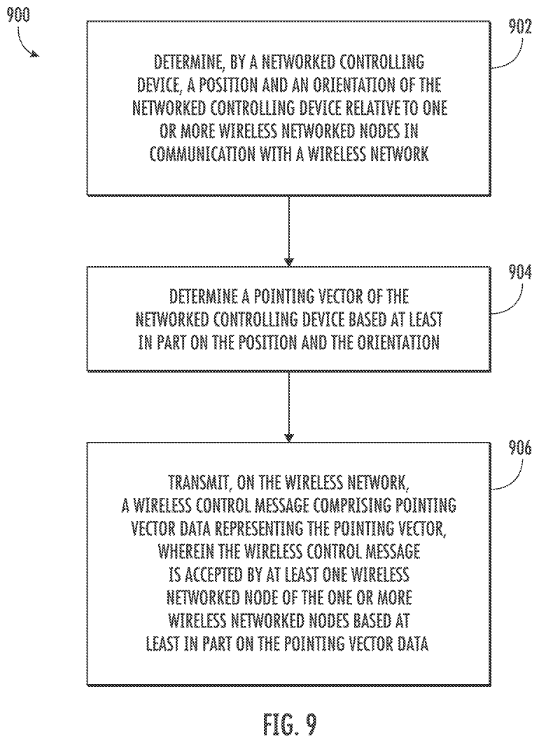

Referring now to FIG. 9, an example process 900 for transmitting a wireless control message (e.g., wireless control message 660) to a target wireless networked node (e.g., target wireless networked node 550, 650) is provided. At block 902, a networked controlling device (e.g., networked controlling device 106, 206, 306, 406, 506, 606) determines a position and an orientation of the networked controlling device relative to one or more wireless networked nodes (e.g., wireless networked node 102a-102f, 302a-302f, 442a-442c, 502a-502f, 550, 602a-602j, 650) in communication with a wireless network (e.g., wireless network 108, wireless network mesh 664). As described herein, the position of the networked controlling device within a network device environment and relative to a defined coordinate system may be determined using any positioning technique, such as triangulation and/or trilateration. A networked controlling device may utilize one or more motion sensing devices (e.g., motion sensing device 228) to determine an orientation of the networked controlling device in relation to the defined coordinate system. In some embodiments, the orientation of the networked controlling device may be represented as three angles representing elemental rotations about the axis of the defined coordinate system.

At block 904, the networked controlling device determines a pointing vector (e.g., pointing vector 552, 852) of the networked controlling device based at least in part on the position and the orientation. A pointing vector represents the direction in which the networked controlling device is pointed. The pointing vector is determined based on the position of the networked controlling device within the defined coordinate system and the orientation of the networked controlling device relative to the defined coordinate system. In some embodiments, the networked controlling device may include a pointing end (e.g., pointing end 106a, 506a). The pointing end may indicate the direction of orientation of the networked controlling device. The networked controlling device may further determine an error associated with the position of the networked controlling device and the orientation of the networked controlling device. In some embodiments, a geometric shape, such as a cone, or frustum of a cone may represent the error of the pointing vector. The networked controlling device may determine the dimensions of the geometric shape to represent the error associated with the pointing vector.

A block 906, the networked controlling device transmits, on the wireless network, a wireless control message (e.g., wireless control message 660) comprising pointing vector data representing the pointing vector, wherein the wireless control message is accepted by at least one wireless networked node of the one or more wireless networked nodes based at least in part on the pointing vector data. The networked controlling device transmits a wireless control message comprising a payload (e.g., payload 660b). In some embodiments, in which the target wireless networked node is identified by the networked controlling device, the wireless control message may further comprise an address (e.g., address 660a). The payload includes pointing vector data enabling a wireless networked node to determine the pointing vector of the networked controlling device and associated error. The wireless networked node is configured to determine if the position of the wireless networked node intersects the pointing vector represented by the pointing vector data. In an instance in which the position of the wireless networked node intersects the pointing vector, the wireless control message is accepted and executed. In some embodiments, a task may be executed by the target wireless networked node, for example, a register or sensor value may be read and returned, a configuration parameter may be updated, a setting may be adjusted, the state of the target wireless networked node may be altered, or any other task may be executed. In an instance in which the position of the wireless networked node does not intersect the pointing vector, the wireless control message is ignored and/or retransmitted.

While this detailed description has set forth some embodiments of the present invention, the appended claims cover other embodiments of the present invention which differ from the described embodiments according to various modifications and improvements. For example, one skilled in the art may recognize that such principles may be applied to any electronic device that may be used by a user to control a wireless networked node. For example, a remote control, a dedicated networked controlling device, a mobile phone, a smart ring, smart glasses, smart watch, or any other mobile electronic device.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A networked controlling device, comprising one or more processors and one or more storage devices storing instructions that are operable, when executed by the one or more processors, to cause the one or more processors to:
determine a position and an orientation of the networked controlling device relative to one or more wireless networked nodes in communication with a wireless network;
determine a pointing vector of the networked controlling device based at least in part on the position and the orientation; and
transmit, on the wireless network, a wireless control message comprising pointing vector data representing the pointing vector,
wherein the wireless control message is accepted by at least one wireless networked node of the one or more wireless networked nodes based at least in part on the pointing vector data.

2. The networked controlling device of claim 1, further comprising:
a motion sensing device, wherein the orientation of the networked controlling device is determined based at least in part on the motion sensing device.

3. The networked controlling device of claim 2, wherein the motion sensing device comprises an inertial measurement unit.

4. The networked controlling device of claim 1, wherein the orientation of the networked controlling device is defined by three angles representing elemental rotations within a coordinate system, and wherein the pointing vector data comprises the three angles.

5. The networked controlling device of claim 1, wherein the position is determined by a trilateration process based on a distance of the networked controlling device from a plurality of the one or more wireless networked nodes.

6. The networked controlling device of claim 5, wherein the trilateration process comprises an ultra-wideband (UWB) trilateration process.

7. The networked controlling device of claim 1, wherein the position is determined by a triangulation process.

8. The networked controlling device of claim 7, wherein the one or more wireless networked nodes comprises:
a first wireless networked node; and
a second wireless networked node,
wherein the position of the networked controlling device is determined based at least in part on (a) a first distance between the first wireless networked node and the second wireless networked node, (b) a first angle of arrival of a first wireless message received at the first wireless networked node from the networked controlling device, and (c) a second angle of arrival of a second wireless message received at the second wireless networked node from the networked controlling device.

9. The networked controlling device of claim 1, wherein the wireless control message is broadcast on the wireless network to all wireless networked nodes on the wireless network within range of the networked controlling device.

10. The networked controlling device of claim 1, further comprising:
a pointing end, wherein the pointing vector originates at the pointing end of the networked controlling device.

11. The networked controlling device of claim 1, wherein the wireless network is a Bluetooth low-energy network.

12. A computer-implemented method for controlling a wireless networked node, the method comprising:
determining, by a networked controlling device, a position and an orientation of the networked controlling device relative to one or more wireless networked nodes in communication with a wireless network;
determining a pointing vector of the networked controlling device based at least in part on the position and the orientation; and
transmitting, on the wireless network, a wireless control message comprising pointing vector data representing the pointing vector,
wherein the wireless control message is accepted by at least one wireless networked node of the one or more wireless networked nodes based at least in part on the pointing vector data.

13. The computer-implemented method of claim 12, wherein the orientation of the networked controlling device is determined based at least in part on a motion sensing device.

14. The computer-implemented method of claim 12, wherein the orientation of the networked controlling device is defined by three angles representing elemental rotations within a coordinate system, and wherein the pointing vector data comprises the three angles.

15. The computer-implemented method of claim 12, wherein the position is determined by a trilateration process based on a distance of the networked controlling device from a plurality of the one or more wireless networked nodes.

16. The computer-implemented method of claim 12, wherein the position is determined by a triangulation process.

17. The computer-implemented method of claim 12, wherein the wireless control message is broadcast on the wireless network to all wireless networked nodes on the wireless network within range of the networked controlling device.

18. The computer-implemented method of claim 12, wherein the wireless network is a Bluetooth low-energy network.

19. A wearable electronic device, comprising:
a networked controlling device comprising:
a user input mechanism,
one or more processors, and
one or more storage devices storing instructions that are operable, when executed by the one or more processors, to cause the one or more processors to:
determine a position and an orientation of the networked controlling device relative to one or more wireless networked nodes in communication with a wireless network;
determine a pointing vector of the networked controlling device based at least in part on the position and the orientation; and
transmit, on the wireless network, a wireless control message based on a user input using the user input mechanism,
wherein the wireless control message comprises pointing vector data representing the pointing vector,
wherein the wireless control message is accepted by at least one wireless networked node of the one or more wireless networked nodes based at least in part on the pointing vector data; and
an attaching mechanism, configured to attach the networked controlling device to a portion of the user.

20. The wearable electronic device of claim 19, further comprising:
a motion sensing device, wherein the orientation of the networked controlling device is determined based at least in part on the motion sensing device.

21. A wireless networked node, comprising one or more processors and one or more storage devices storing instructions that are operable, when executed by the one or more processors, to cause the one or more processors to:
receive, from a wireless network, a wireless control message comprising pointing vector data representing the pointing vector of a networked controlling device,
wherein the pointing vector is determined based on a position and an orientation of the networked controlling device relative to one or more wireless networked nodes comprising at least the wireless networked node;
determine that the pointing vector intersects a wireless networked node location associated with the wireless network node; and
execute one or more control message instructions based on the wireless control message.
